(19) United States
(12) Patent Application Publication
(10) Pub. No.: US 2024/0014388 A1
(43) Pub. Date: Jan. 11, 2024

(54) NEGATIVE ELECTRODE BODY, LITHIUM ION BATTERY, AND METHOD OF PRODUCING ACTIVE MATERIAL FOR LITHIUM ION BATTERY

(71) Applicant: TOYOTA JIDOSHA KABUSHIKI KAISHA, Toyota-shi (JP)

(72) Inventors: Mitsutoshi Otaki, Susono-shi (JP); Jun Yoshida, Mishima-shi (JP); Shinji Nakanishi, Mishima-shi (JP); Yasuhiro Yamaguchi, Kariya-shi (JP); Tatsuya Eguchi, Kariya-shi (JP); Masanori Harata, Kariya-shi (JP); Kota Urabe, Kariya-shi (JP); Tomohiro Niimi, Kariya-shi (JP); Kayoko Yukawa, Kariya-shi (JP)

(73) Assignee: TOYOTA JIDOSHA KABUSHIKI KAISHA, Toyota-shi (JP)

(21) Appl. No.: 18/219,363

(22) Filed: Jul. 7, 2023

(30) Foreign Application Priority Data
Jul. 8, 2022 (JP) 2022-110771

(51) Int. Cl. H01M 4/38; H01M 4/134; H01M 4/58; H01M 4/48; H01M 10/0525; H01M 4/136; C01B 33/02

(52) U.S. Cl. CPC H01M 4/386; H01M 4/134; H01M 4/582; H01M 4/48; H01M 10/0525; H01M 4/136; C01B 33/02; H01M 2004/027

(57) ABSTRACT

A negative electrode body of the present disclosure is a negative electrode body for a lithium ion battery having a negative electrode current collector layer and a negative electrode active material layer, wherein the negative electrode active material layer contains Si particles having a clathrate type structure as a negative electrode active material, wherein the negative electrode active material layer contains 0.850 mass % to 5.000 mass % of Al with respect to a mass of the negative electrode active material layer, and wherein the Si particles contain 0.040 mass % to 0.250 mass % of Al with respect to a mass of the Si particles.

### CROSS-REFERENCE TO RELATED APPLICATION

This application claims priority to Japanese Patent Application No. 2022-110771 filed on Jul. 8, 2022, incorporated herein by reference in its entirety.

### BACKGROUND

### 1. Technical Field

The present disclosure relates to a negative electrode body, a lithium ion battery, and a method of producing an active material for a lithium ion battery.

### 2. Description of Related Art

Batteries have been actively developed in recent years. For example, in the automotive industry, batteries used in battery electric vehicles or hybrid electric vehicles have been developed. In addition, Si is known as an active material used in batteries.

Si has a large theoretical capacity and is effective in increasing the energy density of batteries. However, Si undergoes a large change in volume during charging and discharging.

In order to address such problems, Si having a clathrate structure has been focused on.

Japanese Unexamined Patent Application Publication No. 2021-158003 (JP 2021-158003 A) discloses an active material having a silicon clathrate type II crystal phase and having a composition of NaₓSi_{1.36} (1.98<x<2.54).

In addition, Japanese Unexamined Patent Application Publication No. 2022-34998 (JP 2022-34998 A) discloses a method of producing a negative electrode active material containing a silicon clathrate II, including a reaction process in which a reaction raw material containing a NaSi alloy containing Na and Si and a Na trapping agent in a contact state is heated, Na derived from the NaSi alloy is reacted with the Na trapping agent, and the amount of Na in the NaSi alloy is reduced.

### SUMMARY

As described above, Si particles as an active material are effective in increasing the energy density of batteries, but have a large change in the volume during charging and discharging. The expansion and contraction of the active material causes a variation in the restraint pressure of batteries. As a method of reducing a variation in the restraint pressure of batteries, reducing expansion and contraction of the active material due to charging and discharging is conceivable.

A main object of the present disclosure is to provide an electrode body that can reduce a variation in a restraint pressure of a battery during charging and discharging.

The inventors found that the above object can be achieved by the following aspects.

### <<Aspect 1>>

A negative electrode body for a lithium ion battery having a negative electrode current collector layer and a negative electrode active material layer,
wherein the negative electrode active material layer contains Si particles having a clathrate type structure as a negative electrode active material,
wherein the negative electrode active material layer contains 0.850 mass % to 5.000 mass % of Al with respect to a mass of the negative electrode active material layer, and
wherein the Si particles contain 0.040 mass % to 0.250 mass % of Al with respect to a mass of the Si particles.

### <<Aspect 2>>

The negative electrode body according to Aspect 1,
wherein the negative electrode body contains 1.500 mass % or more of Al with respect to a total mass of the negative electrode active material layer, and
wherein the Si particles contain 0.080 mass % or more of Al with respect to a mass of the Si particles.

### <<Aspect 3>>

The negative electrode body according to Aspect 1 or 2,
wherein the negative electrode active material layer contains Al-containing particles that are electrochemically inactive under a working voltage of a lithium ion battery.

### <<Aspect 4>>

The negative electrode body according to Aspect 3,
wherein the Al-containing particles contain F or O.

### <<Aspect 5>>

The negative electrode body according to Aspect 4,
wherein the Al-containing particles are AlF₃ or Al₂O₃.

### <<Aspect 6>>

The negative electrode body according to any one of Aspects 1 to 5,
wherein the Si particles have a porous structure.

### <<Aspect 7>>

The negative electrode body according to any one of Aspects 1 to 6,
wherein the Si particles have a clathrate type II structure.

### <<Aspect 8>>

A lithium ion battery in which the negative electrode body according to any one of Aspects 1 to 7, a solid electrolyte layer, and a positive electrode body are laminated in this order.

### <<Aspect 9>>

A method of producing an active material for a lithium ion battery, including:
mixing and heating a NaSi alloy and AlF₃ to obtain a mixture containing Si particles having a clathrate type structure, NaF, and Al-containing particles; and
washing the mixture with an aqueous HNO₃ solution, and then performing filtering and drying.

### <<Aspect 10>>

The production method according to Aspect 9, including
mechanically milling a Si powder and a NaH powder and then heating to obtain the NaSi alloy.

According to the present disclosure, mainly, it is possible to provide an electrode body that can reduce a variation in a restraint pressure of a battery during charging and discharging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of a lithium ion battery 1 according to one embodiment of the present disclosure;

FIG. 2 is an electron image of a negative electrode active material layer of Example 2 measured through SEM-EDX;

FIG. 3 is an electron image of the negative electrode active material layer of Example 2 measured through SEM-EDX;

FIG. 4 is an electron image of the negative electrode active material layer of Example 2 measured through SEM-EDX; and

FIG. 5 is an electron image of the negative electrode active material layer of Example 2 measured through SEM-EDX.

### DETAILED DESCRIPTION OF EMBODIMENTS

Hereinafter, embodiments of the present disclosure will be described in detail. Here, the present disclosure is not limited to the following embodiments, and various modifications can be performed within the scope of the gist of the disclosure.

<<Negative Electrode Body>>

A negative electrode body of the present disclosure has at least a negative electrode current collector and a negative electrode active material layer. Another layer may be interposed between the negative electrode current collector and the negative electrode active material layer. In addition, the negative electrode active material layer of the present disclosure contains at least Si particles having a clathrate type structure as an active material. The negative electrode active material layer may further contain those other than Si particles having a clathrate type structure such as Si particles that do not have a clathrate type structure as a negative electrode active material, and may contain a solid electrolyte, a conductive assistant and the like. The negative electrode body contains 0.850 mass % to 5.000 mass % of Al with respect to a total mass of the negative electrode body, and the Si particles contain 0.040 mass % to 0.250 mass % of Al with respect to a total mass of the Si particles.

When Si particles having a clathrate type structure contain 0.040 mass % to 0.250 mass % of Al with respect to a total mass of the Si particles, it is conceivable that the framework size of the crystal structure of the Si particles increases, and it is conceivable that the expansion and contraction of the Si particles themselves due to introduction of lithium into a basket structure portion in the clathrate type structure during battery charging is restricted.

Si particles having a clathrate type structure may contain 0.040 mass % or more, 0.060 mass % or more, 0.080 mass % or more, or 0.100 mass % or more of Al and may contain 0.250 mass % or less, 0.240 mass % or less, 0.200 mass % or less, or 0.180 mass % or less of Al with respect to a total mass of the Si particles.

When the amount of Al contained in the Si particles is 0.04 mass % or more, an effect of reducing the restraint pressure is sufficiently obtained. On the other hand, when the amount of Al contained in the Si particles is 0.250 mass % or less, a reduced percentage of the Si portion of the clathrate type structure with respect to a total mass of the Si particles due to the Al content is sufficiently low, and the influence on the energy efficiency per battery mass is sufficiently small.

In order to reduce the restraint pressure, the amount of Al contained in the Si particles with respect to all Si particles is particularly preferably 0.080 mass % or more.

In the negative electrode body of the present disclosure, when Si particles having a clathrate type structure contain 0.040 mass % to 0.250 mass % of Al with respect to a total mass of the Si particles and the negative electrode active material layer contains 0.850 mass % to 5.000 mass % of Al with respect to a total mass of the negative electrode active material layer, Al is contained in Si particles and is also present in a predetermined amount in a portion of the negative electrode active material layer other than Si particles as a negative electrode active material.

As Al present in the negative electrode active material other than Si particles, for example, Al-containing particles and metal Al may be exemplified, and they may function as a bridge that reduces destruction/pulverization of Si particles in an active material due to pressing during production of the negative electrode body and/or batteries and a variation in the restraint pressure due to charging and discharging of batteries.

The negative electrode active material layer may contain 0.850 mass % or more, 1.000 mass % or more, 1.50 mass % or more, or 2.000 mass % or more of Al and may contain 5.000 mass % or less, 4.800 mass % or less, 3.500 mass % or less, or 2.500 mass % or less of Al with respect to a total mass of the negative electrode active material layer.

When the amount of Al contained in the negative electrode active material layer is 0.850 mass % or more, an effect of reducing the restraint pressure is particularly large. On the other hand, when the amount of Al contained in the negative electrode active material layer is 5.000 mass % or less, the amount of Si particles with respect to a total mass of the negative electrode active material layer increases, and the energy efficiency per battery mass increases.

In order to reduce the restraint pressure, the amount of Al contained in the negative electrode active material layer with respect to a total mass of the negative electrode active material layer is particularly preferably 1.500 mass % or more.

Although not limited by this principle, as described above, in a lithium ion battery composed using the negative electrode body of the present disclosure, and particularly, a lithium ion solid battery having a configuration in which a positive electrode body, a solid electrolyte layer, and the negative electrode body of the present disclosure are laminated in this order, it is conceivable that, since the expansion and contraction of Si particles themselves are reduced, and destruction/pulverization of Si particles during production of lithium ion batteries or during charging and discharging of lithium ion batteries are reduced, a variation in the restraint pressure of batteries due to charging and discharging is reduced.

Here, the amount of Al (mass %) with respect to a total mass of the negative electrode active material layer and the amount of Al (mass %) with respect to a total mass of the Si particles can be measured by a conventionally known technique such as energy dispersive X-ray spectroscopy (EDX), ICP, GDOES, or XRF.

<Negative Electrode Current Collector Layer>

The material used for the negative electrode current collector layer is not particularly limited, and any material that can be used as a negative electrode current collector of a battery can be appropriately used, and examples thereof include stainless steel (SUS), aluminum, copper, nickel, iron, titanium, carbon, and resin current collectors, but the present disclosure is not limited thereto.

The shape of the negative electrode current collector layer is not particularly limited, and examples thereof include a foil shape, a plate shape, and a mesh shape. Among these, a foil shape is preferable.

<Negative Electrode Active Material Layer>

The negative electrode active material layer contains Si particles as a negative electrode active material. The negative electrode active material layer further contains an Al-containing component in addition to the Si particles. In addition, the negative electrode active material layer may optionally contain a solid electrolyte, a conductive assistant, and a binder.

Here, when the negative electrode active material layer contains a solid electrolyte, the mass ratio of the Si particles and the solid electrolyte in the negative electrode active material layer (the mass of Si particles:the mass of the solid electrolyte) is preferably 85:15 to 30:70 and more preferably 80:20 to 40:60.

(Si Particles)

Si particles have a clathrate type structure.

The clathrate type structure may be a clathrate type II structure. This is because Si having a clathrate type II structure can occlude more lithium in its internal basket structure than a clathrate type I structure, and the degree of expansion and contraction during charging and discharging tends to be low.

The Si particles may have both a clathrate type I portion and a clathrate type II portion.

The mass ratio of the clathrate type II structure portion with respect to all Si particles may be 50.00 mass % to 99.05 mass %. The mass ratio of the clathrate type II structure portion with respect to all Si particles may be 50.00 mass % or more, 60.00 mass % or more, 70.00 mass % or more, or 80.00 mass % or more, and may be 99.05 mass % or less, 98.00 mass % or less, 95.00 mass % or less, or 90.00 mass % or less.

In addition, the Si particles more preferably have a porous structure.

The presence of a porous structure may be confirmed from an image obtained using, for example, a scanning microscope (SEM).

In addition, the porous structure may be a structure having a plurality of pores, and more specifically, a nanoporous structure, a mesoporous structure, or a macroporous structure. The nanoporous structure is, for example, a porous structure having a pore size distribution of 0.5 nm to 2.0 nm. The mesoporous structure is, for example, a porous structure having a pore size distribution of 2.0 nm to 50.0 nm. The macroporous structure is, for example, a porous structure having a pore size distribution of nm to 1000.0 nm. Here, the pore size distribution of Si particles can be measured by, for example, a N₂ gas adsorption method.

The average particle size (D50) of the Si particles is not particularly limited, and is, for example, 10 nm or more, and may be 100 nm or more. On the other hand, the average particle size (D50) of the Si particles is, for example, 50 μm or less, and may be 20 μm or less. The average particle size (D50) can be calculated from measurement using, for example, a laser diffraction particle size distribution meter and a scanning electron microscope (SEM).

(Al-Containing Component)

The Al-containing component may be, for example, Al-containing particles and/or metal Al.

When the Al-containing component is Al-containing particles, the component may be Al-containing particles that are electrochemically inactive under a working voltage of lithium ion batteries. Examples of such Al-containing particles include particles that further contain F and/or O in addition to Al, and more specifically, AlF₃ and Al₂O₃, but the present disclosure is not limited thereto.

When the Al-containing component is Al-containing particles, the average particle size (D50) of the Al-containing particles is not particularly limited, and is, for example, 10 nm or more, and may be 100 nm or more. On the other hand, the average particle size (D50) of the Al-containing particles is, for example, 50 μm or less, and may be 20 μm or less. The average particle size (D50) can be calculated from measurement using, for example, a laser diffraction particle size distribution meter and a scanning electron microscope (SEM).

(Solid Electrolyte)

The material of the solid electrolyte is not particularly limited, and materials that can be used as solid electrolytes used in lithium ion batteries can be used. For example, the solid electrolyte may be a sulfide solid electrolyte, an oxide solid electrolyte, or a polymer electrolyte, but the present disclosure is not limited thereto.

Examples of sulfide solid electrolytes include sulfide-based amorphous solid electrolytes, sulfide-based crystalline solid electrolytes, and argyrodite type solid electrolytes, but the present disclosure is not limited thereto.

Specific examples of sulfide solid electrolytes include Li₂S—P₂S₅ types (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂Si₂, etc.), LiI—Li₂S—P₂O₅, LiI—Li₃PO₄—P₂S₅, Li₇₋ₓPS₆₋ₓClₓ and the like; and combinations thereof, but the present disclosure is not limited thereto.

Examples of oxide solid electrolytes include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, and Li₃₊ₓPO₄₋ₓNₓ(LiPON), but the present disclosure is not limited thereto.

Sulfide solid electrolytes and oxide solid electrolytes may be glass or crystallized glass (glass-ceramic).

Examples of polymer electrolytes include polyethylene oxide (PEO), polypropylene oxide (PPO), and copolymers thereof, but the present disclosure is not limited thereto.

(Conductive Assistant)

The conductive assistant is not particularly limited. Examples of conductive assistants include carbon materials such as vapor grown carbon fibers (VGCF), ketjen black (KB), acetylene black (AB), and carbon nanofibers, and metal materials, but the present disclosure is not limited thereto.

(Binder)

The binder is not particularly limited. Examples of binders include materials such as polyvinylidene fluoride (PVdF), butadiene rubber (BR), polytetrafluoroethylene (PTFE) and styrene butadiene rubber (SBR) and combinations thereof, but the present disclosure is not limited thereto.

<<Lithium Ion Battery>>

The lithium ion battery of the present disclosure may include the electrode body of the present disclosure as a negative electrode body, a solid electrolyte layer, and a positive electrode body layer in this order.

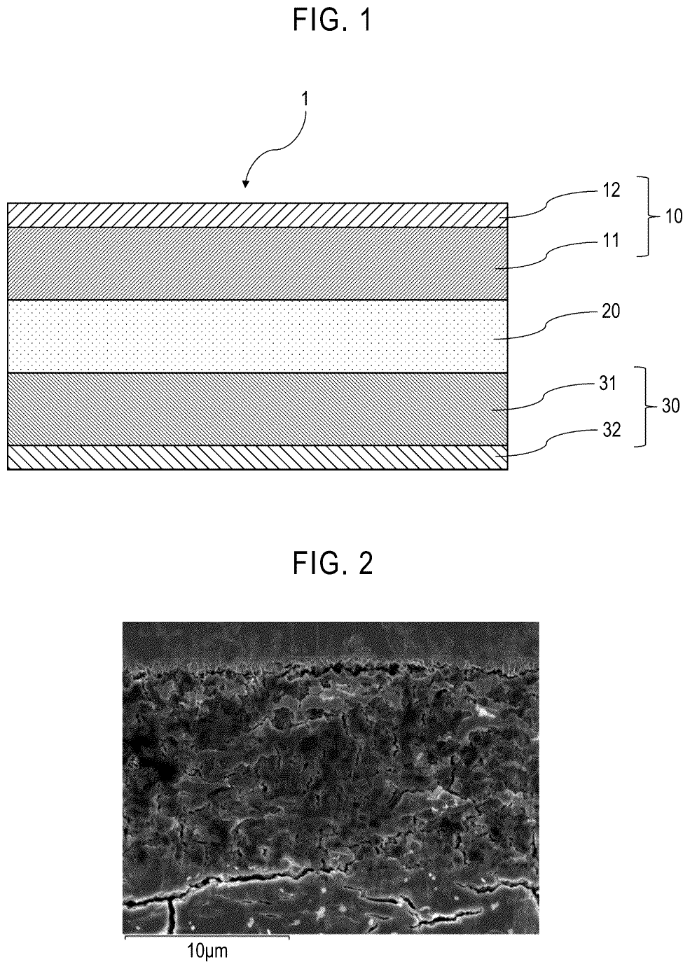

FIG. 1 is a schematic view of a lithium ion battery 1 according to a first embodiment of the present disclosure.

As shown in FIG. 1, the lithium ion battery 1 according to the first embodiment of the present disclosure includes the negative electrode body 10 of the present disclosure, a solid electrolyte layer 20 as an electrolyte layer, and a positive electrode body in this order. Here, a negative electrode body 10 is composed of a negative electrode current collector layer 12 and a negative electrode active material layer 11. Here, the negative electrode current collector layer 12 and the negative electrode active material layer 11 are laminated to each other so that the negative electrode active material layer 11 is in contact with the solid electrolyte layer 20. Similarly, the positive electrode body 30 is composed of the negative electrode current collector layer 12 and the negative electrode active material layer 11. Here, a positive electrode current collector layer 32 and a positive electrode active material layer 31 are laminated to each other so that the positive electrode active material layer 31 is in contact with the solid electrolyte layer 20.

The lithium ion battery of the present disclosure can be restrained by a restraint member from both sides of the lamination direction, that is, the direction in which the negative electrode body of the present disclosure, the electrolyte layer, and the positive electrode body layer are laminated. As the restraint member, for example, a restraint member that is generally used in lithium ion batteries, such as an end plate, can be used.

<Negative Electrode Body>

The lithium ion battery of the present disclosure includes the negative electrode body of the present disclosure.

The thickness of the negative electrode active material layer of the negative electrode body is, for example, 0.1 to 1,000 μm. The thickness of the negative electrode active material layer is particularly preferably 1 to 100 μm and more preferably 30 to 100 μm.

<Solid Electrolyte Layer>

The solid electrolyte layer contains at least a solid electrolyte. In addition, the solid electrolyte layer may contain, as necessary, a binder and the like, in addition to the solid electrolyte. For the solid electrolyte and the binder, the description regarding the solid electrolyte and the binder in the above “<Negative electrode active material layer>” can be referred to.

Here, the solid electrolyte layer may be, for example, a layer in which a resin sheet such as polypropylene is impregnated with an electrolytic solution having lithium ion conductivity.

The electrolytic solution preferably contains a supporting electrolyte and a solvent. Examples of supporting electrolytes (lithium salts) of electrolytic solutions having lithium ion conductivity include inorganic lithium salts such as LiPF₆, LiBF₄, LiClO₄, and LiAsF₆, and organic lithium salts such as LiCF₃SO₃, LiN(CF₃SO₂)₂, LiN(C₂F₅SO₂)₂, LiN(FSO₂)₂, and LiC(CF₃SO₂)₃. Examples of solvents used in the electrolytic solution include cyclic esters (cyclic carbonates) such as ethylene carbonate (EC), propylene carbonate (PC), and butylene carbonate (BC), and chain esters (chain carbonates) such as dimethyl carbonate (DMC), diethyl carbonate (DEC), and ethyl methyl carbonate (EMC). The electrolytic solution preferably contains two or more solvents.

The thickness of the solid electrolyte layer is, for example, 0.1 to 1,000 μm. The thickness of the solid electrolyte layer is preferably 0.1 to 300 μm, and also, particularly preferably 0.1 to 100 μm.

<Positive Electrode Body>

The positive electrode body of the present disclosure has at least a positive electrode current collector and a positive electrode active material layer. Another layer may be interposed between the positive electrode current collector and the positive electrode active material layer. The thickness of the positive electrode active material layer of the positive electrode body is, for example, 0.1 to 1,000 μm. The thickness of the positive electrode active material layer is particularly preferably 1 to 100 μm and more preferably 30 to 100 μm.

(Positive Electrode Current Collector Layer)

The material and the shape used for the positive electrode current collector layer are not particularly limited, and materials and shapes described in the above “<Negative electrode current collector layer>” may be used. Among these, the material of the positive electrode current collector layer is preferably aluminum. In addition, the shape is preferably a foil shape.

(Positive Electrode Active Material Layer)

The positive electrode active material layer is a layer containing a positive electrode active material, an optional solid electrolyte, a conductive assistant, a binder and the like.

Here, when the positive electrode active material layer contains a solid electrolyte, the mass ratio of the positive electrode active material and the solid electrolyte (the mass of the positive electrode active material:the mass of the solid electrolyte) in the positive electrode active material layer is preferably 85:15 to 30:70 and more preferably 80:20 to 40:60.

The material of the positive electrode active material is not particularly limited. For example, the positive electrode active material may be lithium cobaltate (LiCoO₂), lithium nickelate (LiNiO₂), lithium manganate (LiMn₂O₄), a hetero element-substituted Li—Mn spinel of a composition represented by LiCo_{1/3}Ni_{1/3}Mn_{1/3}O₂, Li₁₊ₓMn_{2-x-y}M_{y}O₄ (M is one or more metal elements selected from among Al, Mg, Co, Fe, Ni, and Zn), or the like, but the present disclosure is not limited thereto.

The positive electrode active material may have a coating layer. The coating layer is a layer containing a substance having lithium ion conductivity, has low reactivity with the positive electrode active material and the solid electrolyte, and can maintain the form of the coating layer that does not flow when in contact with the active material or the solid electrolyte. Specific examples of materials constituting the coating layer include Li₄Ti₅O₁₂ and Li₃PO₄ in addition to LiNbO₃, but the present disclosure is not limited thereto.

Examples of shapes of the positive electrode active material include particle shape. The average particle size (D50) of the positive electrode active material is not particularly limited, and is, for example, 10 nm or more, and may be 100 nm or more. On the other hand, the average particle size (D50) of the positive electrode active material is, for example, 50 μm or less, and may be 20 μm or less. The average particle size (D50) can be calculated from measurement using, for example, a laser diffraction particle size distribution meter and a scanning electron microscope (SEM).

For the solid electrolyte, the conductive assistant, and the binder, the description regarding the above “<Electrode active material layer>” can be referred to.

The thickness of the positive electrode active material layer is, for example, 0.1 μm or more and 1000 μm or less.

<<Method of Producing Active Material for Lithium Ion Battery>>

The production method of the present disclosure is a method of producing an active material for a lithium ion battery. The production method of the present disclosure includes mixing and heating a NaSi alloy and AlF₃ to obtain a mixture containing Si particles having a clathrate type structure, NaF, and Al-containing particles, washing the mixture with an aqueous HNO₃ solution, and then performing filtering and drying.

When a NaSi alloy powder and AlF₃ are mixed and heated at a predetermined temperature and time, AlF₃ functions as a Na trapping agent, Na is desorbed from the NaSi alloy, and Si particles having a clathrate type structure, particularly, a clathrate type II structure, are produced.

Heating for obtaining Si particles having a clathrate type structure may be performed at a heating temperature of 250° C. to 500° C. for a heating time of 30 hours to 200 hours, and under an atmosphere inert to Si and Na, for example, under a rare gas atmosphere, more specifically, under an Ar atmosphere.

The heating temperature may be 250° C. or higher, 300° C. or higher, or 350° C. or higher, and may be 500° C. or lower, 450° C. or lower, 400° C. or lower, or 350° C. or lower.

The heating time may be 30 hours or longer, 40 hours or longer, 50 hours or longer, or 100 hours or longer, and may be 200 hours or shorter, 180 hours or shorter, 160 hours or shorter, or 100 hours or shorter.

The average particle size (D50) of AlF₃ is not particularly limited, and may be, for example, 10 μm to 500 μm. The average particle size (D50) can be calculated from measurement using, for example, a laser diffraction particle size distribution meter and a scanning electron microscope (SEM).

The mixing ratio of a NaSi alloy and AlF₃ may be 1:0.100 to 1:0.500 in terms of a molar ratio (NaSi alloy:AlF₃). This molar ratio (NaSi alloy:AlF₃) may be 1:0.150 to 1:0.400 or 1:0.200 to 1:0.3400.

In the production method of the present disclosure, the NaSi alloy powder may be obtained by mechanically milling a Si powder and a NaH powder, and then heating it. Heating may be performed, for example, at a heating temperature of 250 to 500° C. for a heating time of 30 hours to 200 hours, and under an atmosphere inert to Si and Na, for example, under a rare gas atmosphere, more specifically, under an Ar atmosphere.

The heating temperature may be 250° C. or higher, 300° C. or higher, or 350° C. or higher, and may be 500° C. or lower, 450° C. or lower, 400° C. or lower, or 350° C. or lower.

The heating time may be 30 hours or longer, 40 hours or longer, 50 hours or longer, or 100 hours or longer, and may be 200 hours or shorter, 180 hours or shorter, 160 hours or shorter, or 100 hours or shorter.

The Si powder may have a porous structure of primary particles.

The Si powder of which the primary particles have a porous structure can be obtained by, for example, mixing a Si powder raw material and Li under an atmosphere inert to Si and Li, for example, under a rare gas atmosphere, more specifically, under an Ar atmosphere to obtain a LiSi alloy compound, reacting this compound with, for example, ethanol, and removing Li.

### EXAMPLES 1 TO 5 AND COMPARATIVE EXAMPLE 1

### Example 1

### (Synthesis of Si Particles)

A Si powder (Si powder having no voids inside primary particles) was prepared as a Si source. This Si source and Li metal were weighed out at a molar ratio of Li/Si=4.75, and mixed in a mortar in an Ar atmosphere to obtain an alloy compound. The obtained alloy compound was reacted with ethanol in an Ar atmosphere to obtain a Si powder having voids inside the primary particles, that is, a porous structure.

A NaSi alloy was produced using the obtained Si powder and NaH as a Na source. Here, NaH that was washed with hexane in advance was used. The Na source and the Si source were weighed out so that the molar ratio was 1.05:1.00, and mixed using a cutter mill. This mixture was heated in a heating furnace under conditions of an Ar atmosphere at 400° C. for 40 hours to obtain a powdery NaSi alloy.

The obtained NaSi alloy and AlF₃ were weighed out so that the molar ratio was 1.000:0.200, and mixed using a cutter mill to obtain a reaction raw material. The obtained reaction raw material was put into a stainless steel reaction container, and heated and reacted in a heating furnace under conditions of an Ar atmosphere at 290° C. for 120 hours.

This reaction product was washed using a mixed solvent in which HNO₃ and H₂O were mixed at a volume ratio of 10:90, and then filtered, and the filtered solid content was dried at 120° C. for 3 hours or longer to obtain a powder containing Si particles, Al-containing particles and the like.

When the crystal structure of the obtained Si particles was measured by X-ray crystal diffraction, the clathrate type II structure was found.

(Formation of Negative Electrode Body)

A 5 wt % butyl butyrate solution containing butyl butyrate and a polyvinylidene fluoride (PVDF) binder, vapor grown carbon fibers (VGCF) as a conductive assistant, a powder containing synthesized Si particles and Al-containing particles, and a Li₂S—P₂S₅-based glass-ceramic as a sulfide solid electrolyte were put into a polypropylene container, and stirred using an ultrasonic dispersion device (UH-50, commercially available from SMT Co., Ltd.) for 30 seconds. Next, the container was shaken for 30 minutes with a shaker (TTM-1, commercially available from Sibata Scientific Technology Ltd.) to obtain a negative electrode mixture slurry.

The negative electrode mixture was applied onto a Cu foil using an applicator according to a blade method, and dried on a hot plate heated to 100° C. for 30 minutes to obtain a negative electrode body.

(Formation of Solid Electrolyte Layer)

A 5 wt % heptane solution containing heptane and a butylene rubber (BR) binder, and a Li₂SP₂S₅-based glass-ceramic as a sulfide solid electrolyte were put into a polypropylene container, and stirred using an ultrasonic dispersion device (UH-50, commercially available from SMT Co., Ltd.) for 30 seconds. Next, the container was shaken using a shaker (TTM-1, commercially available from Sibata Scientific Technology Ltd.) for 30 minutes to obtain a solid electrolyte slurry.

The solid electrolyte slurry was applied onto an Al foil as a release sheet using an applicator according to a blade method and dried on a hot plate heated to 100° C. for minutes to form a solid electrolyte layer.

Three solid electrolyte layers were produced.

(Formation of Positive Electrode Body)

In a polypropylene container, a 5 wt % butyl butyrate solution containing butyl butyrate and a PVDF binder, LiNi_{1/3}Co_{1/3}Mn_{1/3}O₂ having an average particle size of 6 μm as a positive electrode active material, a Li₂S—P₂S₅-based glass-ceramic as a sulfide solid electrolyte, and VGCF as a conductive assistant were put into the container, and stirred using an ultrasonic dispersion device (UH-50, commercially available from SMT Co., Ltd.) for 30 seconds.

Next, the container was shaken using a shaker (TTM-1, commercially available from Sibata Scientific Technology Ltd.) for 3 minutes, and additionally stirred using an ultrasonic dispersion device for 30 seconds, and shaken using a shaker for 3 minutes to obtain a positive electrode mixture slurry.

The positive electrode mixture slurry was applied onto an Al foil using an applicator according to a blade method, and dried on a hot plate heated to 100° C. for 30 minutes to form a positive electrode body.

(Battery Assembly)

The positive electrode body and a first solid electrolyte layer were laminated in this order. This laminate was set in a roll press machine, and pressed at a press pressure of 100 kN/cm and a press temperature of 165° C. to obtain a positive electrode laminate.

The negative electrode body and a second solid electrolyte layer were laminated in this order. This laminate was set in a roll press machine and pressed at a press pressure of 60 kN/cm and a press temperature of 25° C. to obtain a negative electrode laminate.

In addition, an Al foil as a release sheet was peeled off from the surface of the solid electrolyte layers of the positive electrode laminate and the negative electrode laminate. Then, the Al foil as the release sheet was peeled off from the third solid electrolyte layer.

The sides of the solid electrolyte layers of the positive electrode laminate and the negative electrode laminate and the third solid electrolyte layer were made to face each other, these components were laminated to each other, this laminate was set in a flat uniaxial pressing machine, and temporarily pressed at 100 MPa and 25° C. for 10 seconds, and finally, this laminate was set in a flat uniaxial pressing machine and pressed at a press pressure of 200 MPa and a press temperature of 120° C. for 1 minute. Thereby, an all-solid-state battery was obtained.

### Example 2

Si particles of Example 2 were obtained in the same manner as in Example 1 except that heating conditions for a NaSi alloy and AlF₃ were 310° C. and 60 hours. An all-solid-state battery was obtained in the same manner as in Example 1 using the Si particles.

### Example 3

Si particles of Example 3 were obtained in the same manner as in Example 2 except that the molar ratio of a NaSi alloy and AlF₃ was 1.000:0.210. An all-solid-state battery was obtained in the same manner as in Example 2 using the Si particles.

### Example 4

Si particles of Example 4 were obtained in the same manner as in Example 2 except that the molar ratio of a NaSi alloy and AlF₃ was 1.000:0.336 and AlF₃ from which fine particles were removed using a metal sieve (mesh size of 20 pin) was used. An all-solid-state battery was obtained in the same manner as in Example 2 using the Si particles.

### Example 5

Si particles of Example 5 were obtained in the same manner as in Example 2 except that the molar ratio of a NaSi alloy and AlF₃ was 1.000:0.336. An all-solid-state battery was obtained in the same manner as in Example 2 using the Si particles.

### Comparative Example 1

Si particles were used as a Si source, Na particles were used as a Na source, the Si particles and the Na particles were mixed so that the molar ratio was 1:1, and put into a crucible, sealed under an Ar atmosphere, and heated at 700° C. to obtain a NaSi alloy. The obtained NaSi alloy was heated under conditions of a vacuum (about 1 Pa) and 340° C. to remove Na, and thereby an intermediate having a silicon clathrate type II crystal phase was obtained. The obtained intermediate and Li metal were weighed out at a molar ratio of Li/Si=1.7, and mixed in a mortar in an Ar atmosphere to obtain an alloy compound. The obtained alloy compound was reacted with ethanol in an Ar atmosphere to obtain Si particles in which voids were formed inside the primary particles.

An all-solid-state battery was obtained in the same manner as in Example 1 using the obtained Si particles.

<Measurement of Al Content>

The amount of Al (mass %) in the same negative electrode active material layer that was formed when an all solid state battery of each example was produced was measured through SEM-EDX and the amount of Al (mass %) in the Si particles was measured through TEM-EDX.

<Measurement of Restraint Pressure Variation>

An all solid state battery of each example was restrained at a predetermined restraint pressure using a restraint jig, and the amount of variation in the restraint pressure when constant current-constant voltage charging was performed to 4.55 V at a 10-hour rate ( 1/10 C) was measured. Here, the amount of variation in the restraint pressure was a difference between the maximum value and the minimum value of the restraint pressure.

<Results>

Table 1 shows production conditions for Si particles used in all solid state batteries of examples, the Al content (mass %) in Si particles, the Al content (mass %) in the negative electrode body, and the amount of variation in the restraint pressure during charging and discharging. In addition, FIGS. 2 to 5 show electron images of the negative electrode active material layer of Example 2 measured through SEM-EDX. Here, “classification of AlF₃” in Table 1 indicates the presence of classification using a metal sieve and a mesh size of a metal sieve. In addition, the amount of variation in the restraint pressure is a relative value when the relative in Comparative Example 1 is set to 100.

TABLE 1

| | | | | | Al content | | |
|---|---|---|---|---|---|---|---|
| | | | | | | Al content | |
| | Production conditions | | | | Al content | in negative | |
| | | | Heating | Heating | in Si | electrode | Restraint |
| | NaSi | Classification | temperature | time | particles | body | pressure |
| Example | alloy:AlF₃ | of AlF₃ (μm) | (° C.) | (hours) | (mass %) | (mass %) | variation |
| Comparative | — | — | 340 | — | 0.002 | 0.030 | 100 |
| Example 1 | | | | | | | |
| Example 1 | 1.000:0.200 | no | 290 | 120 | 0.043 | 0.850 | 84 |
| Example 2 | 1.000:0.200 | no | 310 | 60 | 0.087 | 1.730 | 50 |
| Example 3 | 1.000:0.210 | no | 310 | 60 | 0.112 | 2.230 | 25 |
| Example 4 | 1.000:0.336 | 20 | 310 | 60 | 0.166 | 3.330 | 40 |
| Example 5 | 1.000:0.336 | no | 310 | 60 | 0.239 | 4.780 | 40 |

As shown in Table 1, in the all solid state battery of Example 1 in which the Al content in the Si particles was 0.043 mass %, and the Al content in the negative electrode body was 0.850 mass %, a variation in the restraint pressure during charging and discharging was reduced more than in the all solid state battery of Comparative Example 1. Specifically, the restraint pressure variation was 84% of the restraint pressure variation in Comparative Example 1.

Similarly, the all solid state batteries of Examples 2 to 5 also had less variation in the restraint pressure during charging and discharging than the all solid state battery of Comparative Example 1.

Here, the Al content in the Si particles in Comparative Example 1 and the Al content in the negative electrode body were considered to be the amount of Al as impurities contained in the raw materials such as a Si powder.

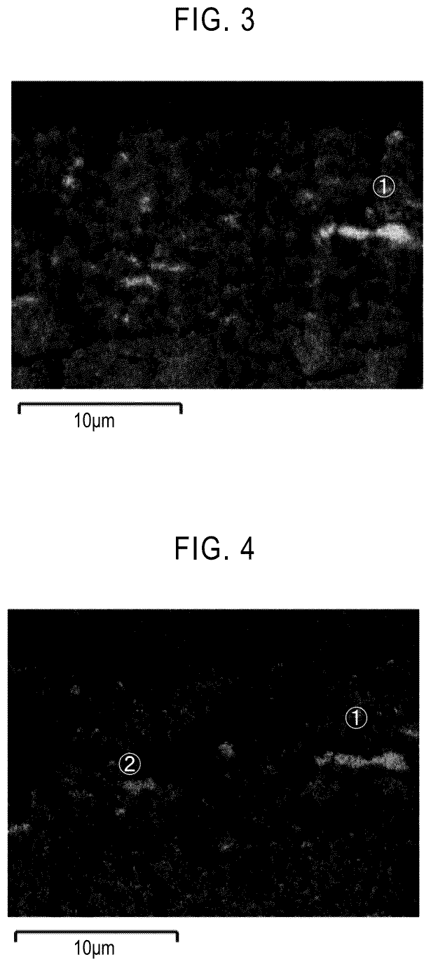

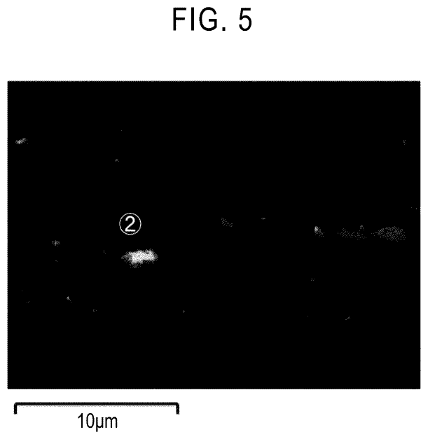

FIG. 2 is an SEM image of the negative electrode active material layer. FIG. 3 shows a distribution of O, FIG. 4 shows a distribution of Al, and FIG. 5 shows a distribution of F. As shown in FIGS. 2 to 5, the Al element in the negative electrode active material layer was detected at the same position as the O element as in (1), and detected at the same position as the F element as in (2). That is, it can be said that the negative electrode active material layer of Example 2 contained particles containing Al and O, and particles containing Al and F. In addition, it was thought that a stable substance as a substance containing the Al element and the O element was Al₂O₃, and a stable substance as a substance containing the Al element and the F element was AlF₃, and thus the negative electrode active material layer of Example 2 contained Al₂O₃ and AlF₃.

What is claimed is:

1. A negative electrode body for a lithium ion battery having a negative electrode current collector layer and a negative electrode active material layer,
wherein the negative electrode active material layer contains Si particles having a clathrate type structure as a negative electrode active material,
wherein the negative electrode active material layer contains 0.850 mass % to 5.000 mass % of Al with respect to a mass of the negative electrode active material layer, and
wherein the Si particles contain 0.040 mass % to 0.250 mass % of Al with respect to a mass of the Si particles.

2. The negative electrode body according to claim 1,
wherein the negative electrode body contains 1.500 mass % or more of Al with respect to a total mass of the negative electrode active material layer, and
wherein the Si particles contain 0.080 mass % or more of Al with respect to a mass of the Si particles.

3. The negative electrode body according to claim 1,
wherein the negative electrode active material layer contains Al-containing particles that are electrochemically inactive under a working voltage of a lithium ion battery.

4. The negative electrode body according to claim 3,
wherein the Al-containing particles contain F or O.

5. The negative electrode body according to claim 3,
wherein the Al-containing particles are AlF₃ or Al₂O₃.

6. The negative electrode body according to claim 1,
wherein the Si particles have a porous structure.

7. The negative electrode body according to claim 1,
wherein the Si particles have a clathrate type II structure.

8. A lithium ion battery in which the negative electrode body according to claim 7, a solid electrolyte layer, and a positive electrode body are laminated in this order.

9. A method of producing an active material for a lithium ion battery, comprising:
mixing and heating a NaSi alloy and AlF₃ to obtain a mixture containing Si particles having a clathrate type structure, NaF, and Al-containing particles; and
washing the mixture with an aqueous HNO₃ solution, and then performing filtering and drying.

10. The production method according to claim 9, comprising
mechanically milling a Si powder and a NaH powder and then heating to obtain the NaSi alloy.
